(19) United States
(12) Patent Application Publication
(10) Pub. No.: US 2023/0366430 A1
(43) Pub. Date: Nov. 16, 2023

(54) PLAIN BEARING UNIT AND ASSOCIATED ASSEMBLY METHODS

(71) Applicant: SKF Aerospace France S.A.S, Montigny-le-Bretonneux (FR)

(72) Inventors: Arnaud TURMEAU, Chabeuil (FR); Aiouba OMAR, Valence (FR)

(21) Appl. No.: 18/304,935

(22) Filed: Apr. 21, 2023

(30) Foreign Application Priority Data
May 11, 2022 (FR) 2204447

(51) Int. Cl. F16C 23/04; F16C 43/02

(52) U.S. Cl. CPC F16C 23/045; F16C 43/02

(57) ABSTRACT

A plain bearing unit includes a spherical bearing including an inner ring, the inner ring having a spherical outer surface, a bore and a groove formed in the bore, and an outer ring having a spherical inner surface mounted on the spherical outer surface of the inner ring. A sleeve is mounted in the bore of the inner ring of the spherical bearing and has an outer surface and a groove formed in the outer surface of the sleeve. A radially elastic retention ring extends inside the groove in the bore of the inner ring of the spherical bearing and extends inside the groove on the outer surface of the sleeve.

### CROSS-REFERENCE

This application claims priority to French Patent Application No. 2204447 filed on May 11, 2022, the entire contents of which are fully incorporated herein by reference.

### BACKGROUND OF THE INVENTION

The present invention relates to bearings, and more particularly to spherical plain bearing units, especially such bearing units used in the aeronautical industry.

In the aeronautical industry, assemblies are often mounted on spherical bearing connections to accommodate deformation of the structures that may lead to expansion phenomena. During maintenance, the shafts are often dismantled from the joints to release the assembly. Generally, a spherical bearing includes an inner ring having a spherical outer surface and an outer ring having a spherical inner surface mounted on the outer surface of the inner ring. To facilitate assembly and dismantling, the inner ring may take the form of a split ring which is made up of multiple parts.

During maintenance operations, the multi-part design of the inner ring of the spherical bearing may give rise to marks on a pin of the joint at the split or splits in the inner ring. These marks may reduce the fatigue strength of such pins and so as to require costly replacement of the pin each time the assembly is dismantled.

To overcome this drawback, it is known to mount an annular sleeve in the bore of the inner ring so as to obtain an uninterrupted, continuous cylindrical contact with the pin. In order to provide a unitary assembly that is easy to assemble and dismantle, it is necessary to secure the sleeve to the inner ring.

The securement of the sleeve to the inner ring may be achieved by providing an annular shoulder on one end of the sleeve, which bears axially against one of the end faces of the inner ring, and a screw thread on the other end of the sleeve. A nut is screwed on the sleeve thread and bears against the other end face of the inner ring. Such a solution has the major drawbacks of being expensive and lacks compactness.

### SUMMARY OF THE INVENTION

The present invention includes a plain bearing unit comprising a spherical bearing having an inner ring comprising a spherical outer surface, and an outer ring comprising a spherical inner surface mounted on the spherical outer surface of the inner ring, and a sleeve having an outer surface mounted in the bore of the inner ring of the spherical bearing.

The plain bearing unit further comprises a radially elastic retention ring which extends inside a groove made in the bore of the inner ring of the spherical bearing, and inside a groove made on the outer surface of the sleeve. Thus, the sleeve and the spherical bearing are axially secured at low cost by virtue of the retention ring, and without increasing the axial bulk of the unit.

Preferably, the retention ring has, in the free state, an inside diameter which is smaller than or equal to the inside diameter of the groove on the outer surface of the sleeve. In such a case, the retention ring fits snugly on the sleeve. Alternatively, the retention ring may have, in the free state, an outside diameter which is greater than or equal to the diameter of the groove in the bore of the inner ring of the spherical bearing. In this case, the retention ring fits snugly on the inner ring.

Preferably, the retention ring is open at a point on its circumference. Alternatively, it is possible to provide a retention ring which is unbroken in the circumferential direction.

The retention ring may be positioned in a median radial plane of the unit. Alternatively, the retention ring may be offset axially with respect to this radial plane.

In one embodiment, the sleeve is provided, at one axial end, with a chamfer connecting the outer surface to an end face of the sleeve. Alternatively, the sleeve may be formed without such a chamfer.

The groove in the bore of the inner ring of the spherical bearing may have two radial walls. Similarly, the groove in the outer surface of the sleeve may have two radial walls.

The present invention also relates to a method for assembling a plain bearing unit as defined above, comprising the following steps:
mounting the retention ring inside the groove in the inner ring of the spherical bearing;
axially inserting the sleeve in the bore of the inner ring of the spherical bearing and of radially deforming the retention ring inside the groove; and
axially pushing the sleeve until the retention ring is inserted in the groove in the sleeve by elastic return and the sleeve and the inner ring of the spherical bearing are secured together axially.

The present invention also relates to a method for assembling a plain bearing unit as defined above, comprising the following steps:
mounting the retention ring inside the groove in the sleeve;
axially inserting the sleeve in the bore of the inner ring of the spherical bearing and of radially deforming the retention ring inside the groove; and
axially pushing the sleeve until the retention ring is inserted in the groove in the inner ring of the spherical bearing by elastic return and the sleeve and the inner ring are secured together axially.

### BRIEF DESCRIPTION OF THE SEVERAL VIEWS OF THE DRAWINGS

The present invention will be better understood on studying the detailed description of an embodiment, provided by way of entirely non-limiting example and illustrated by the appended drawings, in which:

FIG. 1 is a view in section of a plain bearing unit according to an embodiment of the invention;

FIG. 2 is a detail view of FIG. 1; and

FIGS. 4-6 are each a separate view of a section showing the assembly of the plain bearing unit of FIG. 1.

### DETAILED DESCRIPTION OF THE INVENTION

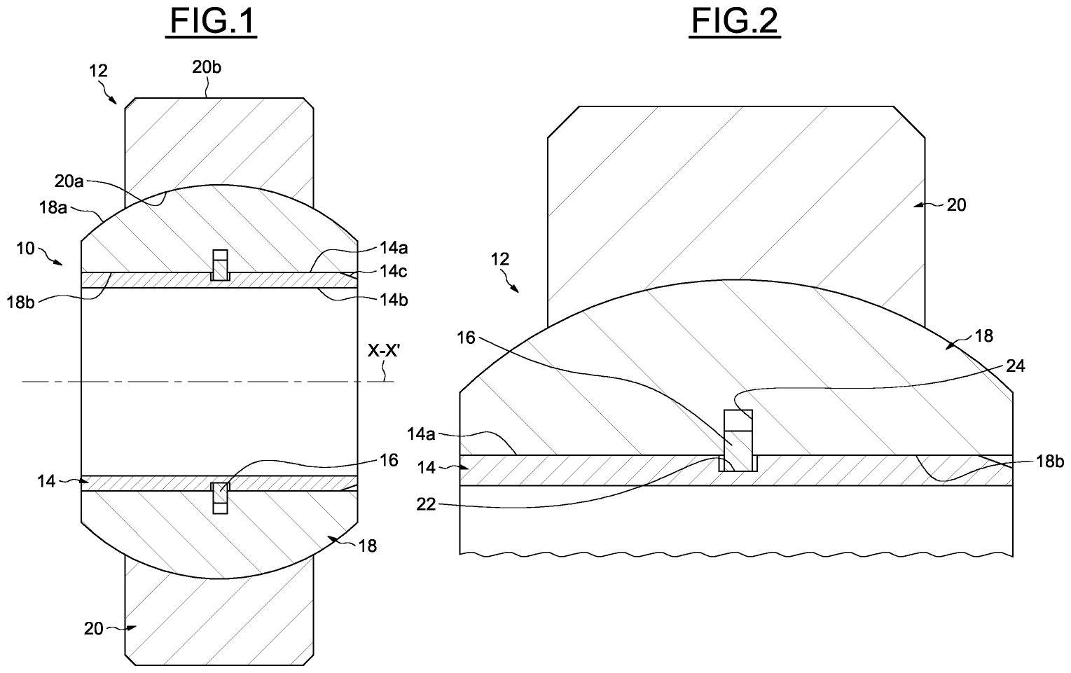

FIG. 1 shows plain bearing unit 10 having an axis X-X′ and basically comprising a spherical bearing 12 and a sleeve 14 mounted in the bore of the spherical bearing 12. As described in further detail below, the unit 10 also comprises a retention ring 16 interposed radially between the spherical bearing 12 and the sleeve 14 to secure them together axially.

The spherical bearing 12 is disposed centrally about the axis X-X′ and includes an inner ring 18 and an outer ring 20 mounted on the inner ring 18. The inner ring 18 and outer ring 20 are preferably made of steel, titanium, nickel alloy, bronze, etc.

The inner ring 18 has a convex spherical outer surface 18a, a cylindrical bore 18b radially opposite the outer surface 18a, and two opposite radial end faces (not indicated) axially delimiting the bore 18b and the outer surface 18a. The inner ring 18 may be one-piece or formed of multiple parts that bear against each another. The inner ring 18 may be split within one or more planes passing through the axis X-X′.

The outer ring 20 has a concave spherical inner surface 20a mounted on the spherical outer surface 18a of the inner ring 18, a cylindrical outer surface 20b radially opposite the inner surface 20a, and two opposite radial end faces (not indicated) axially delimiting the inner and outer surfaces 20a, 20b. The inner surface 20a of the outer ring 20 and the outer surface 18a of the inner ring 18 have complementary shapes and are relatively slidable against each other.

The sleeve 14 is mounted in the bore 18b of the inner ring 18, which provides the bore of the spherical bearing 12. The sleeve 14 is disposed centrally along the axis X-X′ and has an annular shape.

The sleeve 14 is has a convex cylindrical outer surface 14a mounted in the bore 18b of the inner ring of the spherical bearing, a cylindrical bore 14b radially opposite the outer surface 14a, and two opposite radial end faces (not indicated) axially delimiting the bore 14b and the outer surface 14a.

In the depicted embodiment, the end faces of the sleeve 14 are coplanar with those of the inner ring 18 of the spherical bearing 12. Alternatively, the end faces of the sleeve 14 may project outwardly with respect to, or be spaced inwardly from, the end faces of the inner ring 18. Preferably, the sleeve 14 has a chamfer 14c at one axial end connecting the outer surface 14a to one of its end faces.

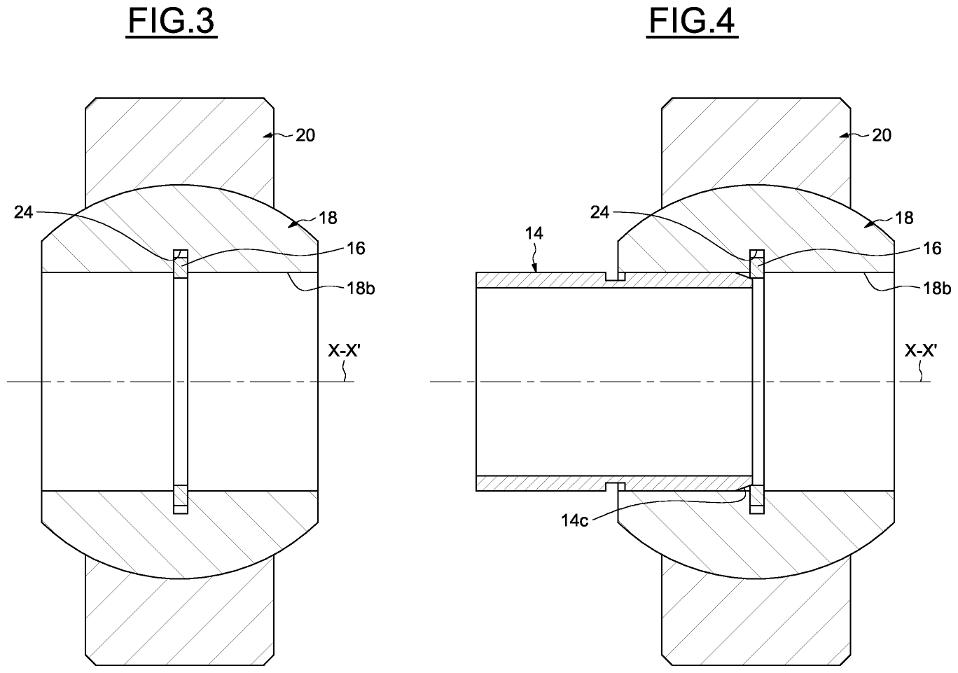

As best shown in FIG. 2, a groove 22 is formed on the outer surface 14a of the sleeve 14. The groove 22 is oriented or faces radially outwardly, i.e., in the direction of the inner ring 18 of the spherical bearing 12. The groove 22 is preferably annular and is delimited radially by two facing radial walls (not indicated) which are connected to one another by a bottom wall. The bottom wall of the groove 22 is offset or spaced radially inwardly from the outer surface 14a of the sleeve 14.

Further, a groove 24 is formed in the bore 18b of the inner ring 18 of the spherical bearing 12. The groove 24 is oriented or faces radially inwardly, i.e., in the direction of the sleeve 14, and radially faces the groove 22 in the sleeve 14. The groove 24 is preferably annular and is delimited radially by two facing radial walls (not depicted) which are connected to one another by a bottom wall. The bottom wall of the groove 24 is offset or spaced radially outwardly from the bore 18b of the inner ring 18. In the depicted embodiment, the groove 24 in the inner ring 18 has an axial width which is less than an axial width of the groove 22 in the sleeve 14. Alternatively, the groove 24 may have an axial width which is greater than or equal to the axial width of the groove 22.

As discussed above, the plain bearing unit 10 further comprises the retention ring 16 for axially securing together the spherical bearing 12 and the sleeve 14. The retention ring 16 is radially elastic; in other words, the retention ring 16 is elastically deformable in the radial direction. The retention ring 16 extends inside the grooves 22, 24 in the sleeve 14 and in the inner ring 18 of the spherical bearing 12. In other words, the retention ring 16 is simultaneously partially disposed within the groove 22 of the sleeve and partially disposed within the groove 24 of the inner ring 18.

The axial thickness of the retention ring 16 is slightly less than the axial width of the groove 24 in the inner ring 18 of the spherical bearing 12 and slightly less than the axial width of the groove 22 in the sleeve 14. Preferably, a radial depth of the groove 24 is greater than a radial thickness of the retention ring 16.

The retention ring 16 is preferably open at a point about the circumference of the ring 16. The retention ring 16 may be formed as a circlip made of metal. Alternatively, the retention ring 16 may be made of synthetic material, such as for example, a rigid polymeric material.

In a free state, the retention ring 16 has an outside diameter greater than an inside diameter of the bore 18b of the inner ring 18 of the spherical bearing 12, and less than a diameter of the groove 24 of the inner ring 18. The diameter of the groove 24 is measured along its bottom wall. As such, there is a radial clearance between the retention ring 16 and the bottom of the groove 24 when the ring 16 is installed within the groove 24.

In the free state, the retention ring 16 has an inside diameter which is less than the diameter of the outer surface 14a of the sleeve 14. In the depicted embodiment, in the free state, the inside diameter of the retention ring 16 is less than or equal to the inside diameter of the groove 22 in the sleeve 14, the inside diameter of the groove 22 being measured along the bottom wall of the groove 22. With such a relative sizing, the retention ring 16 bears radially against the bottom wall of the groove 22. Alternatively, in the free state, the inside diameter of the retention ring 16 may be greater than the diameter of the groove 22 while still being less than the diameter of the outer surface 14a of the sleeve 14.

In the depicted embodiment, the retention ring 16 has rectangular-shaped axial cross sections. However, the retention ring 16 may be alternatively formed having axial cross sections of other shapes, such as for example, square, circular, elliptical, trapezoidal, etc.

In the embodiment shown, the retention ring 16 is positioned in a median radial plane of the plain bearing unit 10. The grooves 22, 24 are therefore also positioned in this median radial plane.

The procedure for assembling the plain bearing unit 10 is as follows. In a first step, the retention ring 16 is mounted inside the groove 24 in the inner ring 18 of the spherical bearing 12, which is already assembled, as shown in FIG. 3. At this stage, the retention ring 16 extends or projects radially inwardly with respect to the bore 18b of the inner ring 18 of the spherical bearing 12. Preferably, there is a radial clearance between the retention ring 16 and the bottom wall of the groove 24 as discussed above.

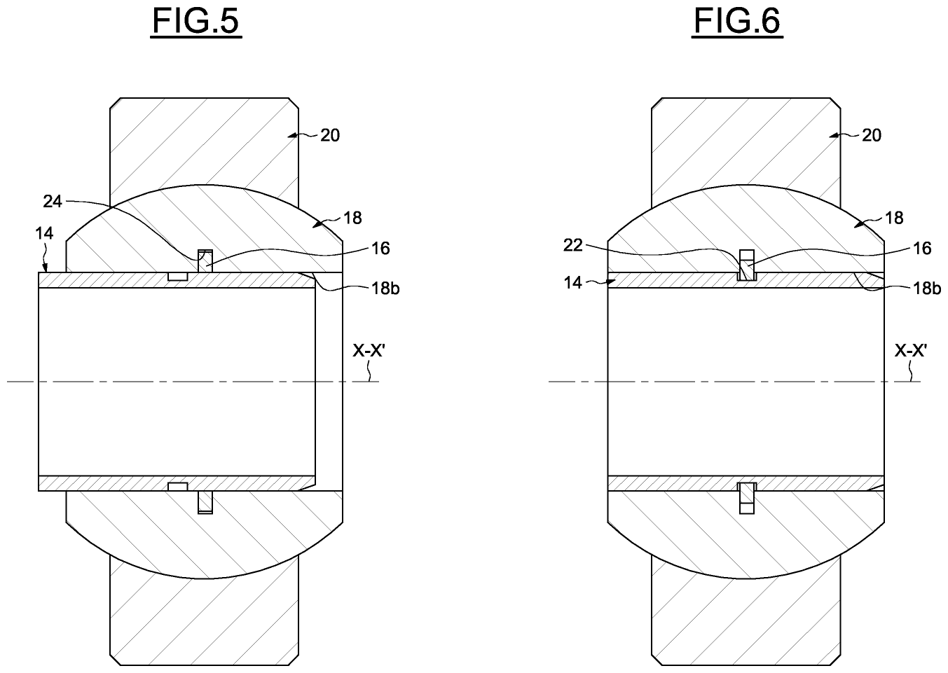

Next, in a second step, the sleeve 14 is inserted axially in the bore 18b of the inner ring 18, and comes into contact with the retention ring 16 as shown in FIG. 4. The chamfer 14c of the sleeve 14 makes it possible to obtain, or at least substantially facilitates, elastic radial deformation of the retention ring 16 inside the groove 24 in the inner ring 18; i.e., the retention ring 16 is deformed to displace radially outwardly into the groove 24. The retention ring 16 is thus entirely housed inside or contained within the groove 24.

In this step, the radial deformation of the retention ring 16 is obtained by virtue of the contact with the sleeve 14. Alternatively, a tool may be used to obtain the radial deformation of the retention ring 16.

Lastly, in a third step, the sleeve 14 continues to be pushed axially into the bore 18b of the inner ring as shown in FIG. 5, until the retention ring 16 is inserted in the groove 22 in the sleeve 14 by elastic return when the grooves 22 and 24 are facing one another, or are radially aligned, as shown in FIG. 6. More specifically, the retention ring 16 tends to return to its original shape due to elasticity after being radially deflected or deformed. The retention ring 16 extends radially in the two grooves 22, 24; in other words, the ring 16 is simultaneously partially disposed within the groove 22 and partially disposed within the groove 24. The sleeve 14 and the inner ring 18 of the spherical bearing 12 are thus secured together axially.

In the embodiment described, during the assembly of the unit 10, the retention ring 16 is initially mounted inside the groove 24 in the inner ring 18 of the spherical bearing 12.

In an alternative assembly method or process, the retention ring 16 is mounted inside the groove 22 in the sleeve 14 in a first step. In this case, after mounting of the ring 16, the retention ring 16 extends or projects radially outwardly with respect to the outer surface 14a of the sleeve 14 and there is a radial clearance between the retention ring 16 and the bottom wall of the groove 22. Preferably, the radial depth of the groove 22 is greater than the radial thickness of the retention ring 16.

Next, in a second step, the sleeve 14 is inserted axially in the bore 18b of the inner ring 18, which may have a chamfer connecting or extending between the bore 18b and one of the end faces of the ring 18. The retention ring 16 deforms radially elastically inside the groove 22 in the sleeve 14. The retention ring 16 is thus entirely housed inside or contained within the groove 22. Alternatively, a tool may be used to obtain the radial deformation of the retention ring 16.

Lastly, in a third step, the sleeve 14 continues to be pushed axially into the bore 18b of the inner ring 18 until the retention ring 16 is inserted in the groove 24 in the inner ring 18 by elastic return when the grooves 22 and 24 are facing one another. That is, the retention ring 16 deflects radially outwardly due to elastic forces when the grooves 22, 24 are radially aligned such that the ring 16 is simultaneously partially disposed within the groove 22 in the sleeve 14 and partially disposed within the groove 24 in the inner ring 18.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A plain bearing unit comprising:
a spherical bearing including an inner ring, the inner ring having a spherical outer surface, a bore and a groove formed in the bore, and an outer ring having a spherical inner surface mounted on the spherical outer surface of the inner ring;
a sleeve mounted in the bore of the inner ring of the spherical bearing and having an outer surface and a groove formed in the outer surface of the sleeve; and
a radially elastic retention ring extending inside the groove in the bore of the inner ring of the spherical bearing and extending inside the groove on the outer surface of the sleeve.

2. The plain bearing unit according to claim 1, wherein the retention ring has an outside diameter, the outside diameter having a value in a free state of the retention ring which is greater than or equal to a value of the diameter of the groove in the bore of the inner ring of the spherical bearing.

3. The plain bearing unit according to claim 1, wherein the retention ring has an inside diameter, the inside diameter having a value in a free state of the retention ring which is less than or equal to a value of an inside diameter of the groove on the outer surface of the sleeve.

4. The plain bearing unit according to claim 1, wherein the retention ring is open at a point on its circumference.

5. The plain bearing unit according to claim 1, wherein the retention ring is positioned in a median radial plane of the plain bearing unit.

6. The plain bearing unit according to claim 1, wherein the sleeve has an axial end and a chamfer formed at the axial end, the chamfer connecting the outer surface of the sleeve to an end face of the sleeve.

7. The plain bearing unit according to claim 1, wherein the groove in the bore of the inner ring of the spherical bearing has two radial walls.

8. The plain bearing unit according to claim 1, wherein the groove in the outer surface of the sleeve has two radial walls.

9. A method of assembling a plain bearing unit, the method comprising the steps of:
providing a spherical bearing including an inner ring, the inner ring having a spherical outer surface, a bore and a groove formed in the bore, and an outer ring having a spherical inner surface mounted on the spherical outer surface of the inner ring, a sleeve having an outer surface and a groove formed in the outer surface, and a radially elastic retention ring;
mounting the retention ring inside the groove in the inner ring of the spherical bearing;
axially inserting the sleeve into the bore of the inner ring of the spherical bearing and of radially deforming the retention ring inside the groove in the inner ring; and
axially pushing the sleeve until the retention ring is inserted into the groove in the sleeve by elastic return such that the sleeve and the inner ring of the spherical bearing are axially secured together.

10. A method for assembling a plain bearing unit, the method comprising the steps of:
providing a spherical bearing including an inner ring, the inner ring having a spherical outer surface, a bore and a groove formed in the bore, and an outer ring having a spherical inner surface mounted on the spherical outer surface of the inner ring, a sleeve having an outer surface and a groove formed in the outer surface, and a radially elastic retention ring;
mounting the retention ring inside the groove in the sleeve;
axially inserting the sleeve into the bore of the inner ring of the spherical bearing and of radially deforming the retention ring inside the groove in the sleeve; and
axially pushing the sleeve until the retention ring is inserted into the groove in the inner ring of the spherical bearing by elastic return such that the sleeve and the inner ring of the spherical bearing are axially secured together.
